(19) United States
(12) Patent Application Publication
(10) Pub. No.: US 2022/0269662 A1
(43) Pub. Date: Aug. 25, 2022

(54) EVENT INTERVAL APPROXIMATION

(71) Applicant: MASTERCARD TECHNOLOGIES CANADA ULC, Vancouver (CA)

(72) Inventors: Andrian Sevastyanov, Burnaby (CA); Marc Grimson, Lexington, MA (US); Sik Suen Chan, Richmond (CA)

(21) Appl. No.: 17/181,574

(22) Filed: Feb. 22, 2021

(51) Int. Cl. G06F 16/22; G06F 7/08; G06Q 30/00

(52) U.S. Cl. CPC G06F 16/2228; G06F 7/08; G06Q 30/0185

(57) ABSTRACT

Methods and systems for approximating event intervals. One system includes an electronic processor configured to receive time-bucketed data. The time bucketed data includes an event count for a bucket. The electronic processor is also configured to determine a set of event intervals for the bucket based on the time-bucketed data, wherein each event interval included in the set of event intervals evenly distributes one or more events associated with the event count across a bucket time window of the bucket. The electronic processor is also configured to store the set of event intervals as interval data in an interval database.

### FIELD

Embodiments described herein relate to event interval, and, more particularly, to event interval approximation based on time-bucketed data

### BACKGROUND

In the context of fraud detection and monitoring, it is useful to recognize patterns of time intervals between similar events, such as how frequently a particular user logs-in to an account from a particular Internet Protocol address. As one example pattern, a user typically logs-in from a work-related IP address between 9:00 am-5:00pm. However, anytime outside of 9:00 am-5:00 pm the user typically logs-in from a non-work-related IP address. Such patterns may be used to support security and anti-fraud functionality.

Traditional systems typically store individual records for each event. However, when dealing with a very large number of events (for example, thousands of events per second), it becomes very costly and, in some cases, not possible to store all the data required to compute the intervals. As one example, a financial institution or website may experience millions of transactions per second. According to this example, the traditional system would require storing millions of individual records for each event.

### SUMMARY

Accordingly, the embodiments described herein provide methods and systems for event interval approximation based on time-bucketed data. Time-bucketed data may include a single record for a bucket, where the single record includes an event count for that bucket (a bucket time window). The embodiments described herein approximate or determine event intervals such that event counts for each bucket are evenly distributed across a whole bucket. Based on the approximated event interval, an assumption may be made as to when the event took place. As one example, the time-bucketed data for a bucket may indicate that four events occurred during a five-minute period, where the four events is the event count and the five-minute period is the bucket time window for that bucket. According to this example, the event interval between the four events may be determined such that the four events are evenly distributed across the five-minute period.

Accordingly, the embodiments described herein use a single record (for example, the time-bucketed data) as opposed to individual records for each event. This reduces storage requirements and consumption. Returning to the example of a financial institution or a website that experiences millions of transactions per second, rather than storing millions of individual records, the embodiments described herein may store a single record including an event count for a bucket.

One embodiment provides a system for approximating event intervals. The system includes an electronic processor configured to receive time-bucketed data, the time bucketed data including an event count for a bucket. The electronic processor is also configured to determine a set of event intervals for the bucket based on the time-bucketed data, wherein each event interval included in the set of event intervals evenly distributes one or more events associated with the event count across a bucket time window of the bucket. The electronic processor is also configured to store the set of event intervals in an interval database.

Another embodiment provides a method for approximating event intervals. The method includes receiving time-bucketed data, the time bucketed data including an event count for a bucket. The method also includes determining, with an electronic processor, a set of event intervals for the bucket based on the time-bucketed data, wherein each event interval included in the set of event intervals evenly distributes one or more events associated with the event count across a bucket time window of the bucket. The method also includes storing the interval data in an interval database.

Yet another embodiment provides a non-transitory, computer-readable medium storing instructions that, when executed by an electronic processor, perform a set of functions. The set of functions includes receiving time-bucketed data, the time bucketed data including event counts for a plurality of buckets. The set of functions also includes, for each bucket included in the plurality of buckets, determining a set of event intervals based on at least a portion of the time-bucketed data, wherein each event interval included in the set of event intervals evenly distributes one or more events across a bucket time window, and storing the set of event intervals as interval data in an interval database.

Other aspects of the embodiments described herein will become apparent by consideration of the detailed description and accompanying drawings.

### BRIEF DESCRIPTION OF THE DRAWINGS

FIG. 1 is a block diagram of a system for approximating event intervals according to some embodiments.

FIG. 2 is a block diagram of a server of the system of FIG. 1 according to some embodiments.

FIG. 3 illustrates a graphical visualization of an example set of time-distributed data.

FIG. 4 is a block diagram of the system of FIG. 1 where one or more components of the system are implemented as part of a fraud detection system according to some embodiments.

FIG. 5 is a flow chart of a method of approximating event intervals using the system of FIG. 1 according to some embodiments.

Other aspects of the embodiments described herein will become apparent by consideration of the detailed description.

### DETAILED DESCRIPTION OF THE EMBODIMENTS

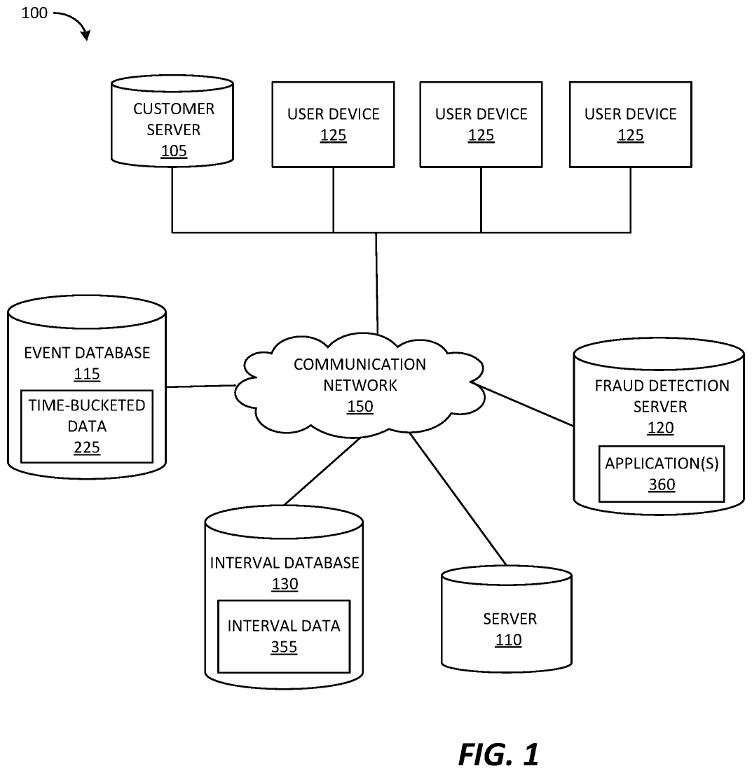

FIG. 1 is a block diagram of a system 100 for approximating event intervals according to some embodiments. In the example shown, the system 100 includes a customer server 105, a server 110, an event database 115, a fraud detection server 120, one or more user devices 125 (referred to herein collectively as “the user devices 125” and individually as “a user device 125”), and a interval database 130. In some embodiments, the system 100 includes fewer, additional, or different components than illustrated in FIG. 1. For example, the system 100 may include multiple customer servers 105, multiple servers 110, multiple event databases 115, multiple fraud detection servers 120, multiple interval databases 130, or a combination thereof. As another example, three user devices 125 are illustrated in FIG. 1 as one example but the system 100 may include more or less user devices 125 in various embodiments.

Also, in some embodiments, one or more of the components of the system 100 may be distributed among multiple servers, databases, or devices, combined within a single server, database, or device, or a combination thereof. As one example, in some embodiments, the functionality associated with the fraud detection server 120 and the server 110 may be combine within a single server. As another example, the event database 115 and the interval database 130 may be included in the server 110, the fraud detection server 120, or a combination thereof and one or both of these databases may be distributed among multiple databases or storage devices. As one example, in some embodiments, the server 110 may communicate with a first event database 115 storing time-bucketed data associated with a particular region or entity and may also communicate with a second event database 115 storing time-bucketed data associated with another region or entity. Also, in some embodiments, multiple servers 110 may access the same event database 115 to provide event interval approximation as described herein for different regions or entities. Accordingly, the event database 115, the interval database 130, or a combination thereof may be shared by multiple regions or entities. As used herein, an entity includes a single user (for example, an end user, a customer, and the like), a group of related users (for example, an organization, such as a financial institution), or a combination thereof.

The customer server 105, the server 110, the event database 115, the fraud detection server 120, the user devices 125, and the interval database 130 communicate over one or more wired or wireless communication networks 150. Portions of the communication networks 150 may be implemented using a wide area network (“WAN”), such as the Internet, a local area network (“LAN”), such as a Bluetooth™ network or Wi-Fi, and combinations or derivatives thereof. Alternatively or in addition, in some embodiments, the components of the system 100 communicate through one or more intermediary devices not illustrated in FIG. 1. Also, in some embodiments, components of the system 100 (or a portion thereof) communicate directly through the communication network 150.

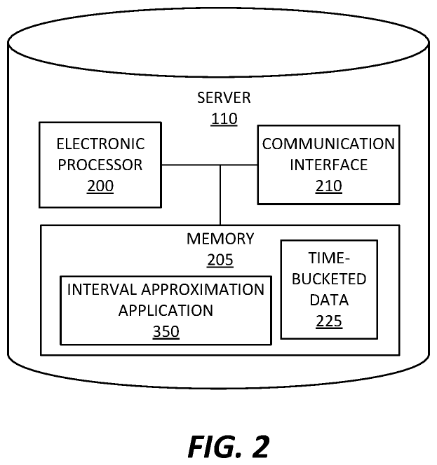

As illustrated in FIG. 2, the server 110 includes an electronic processor 200 (for example, a microprocessor, an application-specific integrated circuit (“ASIC”), or another suitable electronic device), a memory 205 (for example, a non-transitory, computer-readable medium), and a communication interface 210. The electronic processor 200, the memory 205, and the communication interface 210 communicate wirelessly, over one or more communication lines or buses, or a combination thereof. It should be understood that the server 110 may include additional components than those illustrated in FIG. 2 in various configurations and may perform additional functionality than the functionality described herein. For example, in some embodiments, the functionality described herein as being performed by the server 110 may be distributed among multiple servers or devices (including as part of a cloud-based service), may be performed by the fraud detection server 120 (including as part of a fraud detection service offered through a cloud-based service), or a combination thereof.

The communication interface 210 allows the server 110 to communicate with devices external to the server 110. For example, as illustrated in FIG. 1, the server 110 may communicate with the customer server 105, the event database 115, the fraud detection server 120, one or more user devices 125, the interval database 130, or a combination thereof through the communication interface 210. The communication interface 210 may include a port for receiving a wired connection to an external device (for example, a universal serial bus (“USB”) cable and the like), a transceiver for establishing a wireless connection to an external device (for example, over one or more communication networks 150), or a combination thereof.

The electronic processor 200 is configured to access and execute computer-readable instructions (“software”) stored in the memory 205. The software may include firmware, one or more applications, program data, filters, rules, one or more program modules, and other executable instructions. For example, the software may include instructions and associated data for performing a set of functions, including the methods described herein.

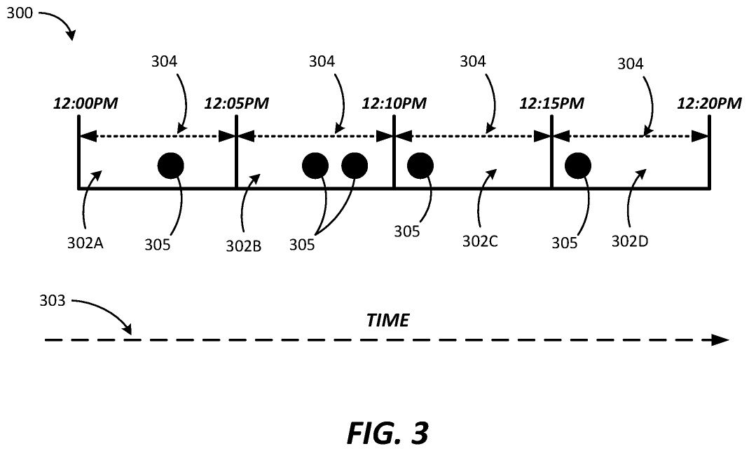

For example, as illustrated in FIG. 2, the memory 205 may store time-bucketed data 225. The time-bucketed data 225 includes an event count for a bucket. An event count refers to a number of events that occurred during a bucket time window of the bucket. A bucket time window may be a fixed time window. However, in other embodiments, the bucket time window may be a variable time window. As one example, FIG. 3 illustrates a graphical visualization 300 of an example set of time-bucketed data. As seen in FIG. 3, the graphical visualization 300 includes a plurality of buckets 302A-D (collectively referred to as “the buckets 302” and individually as “a first bucket 302A,” “a second bucket 302B,” and the like) along a timeline (represented by an arrow 303). The example illustrated in FIG. 3 includes four buckets 302A-D each with a fixed bucket time window (illustrated in FIG. 3 with reference numeral 304) of five minutes. As seen in FIG. 3, each of the buckets 302 includes one or more events 305. For example, the first bucket 302A includes one event 305, the second bucket 302B includes two events 305, the third bucket 302C includes one event 305, and the fourth bucket 302D includes one event 305.

In some embodiments, an event count is associated with one or more data points. A data point may include, for example, a timestamp, an Internet Protocol (“IP”) address, a service provider, an event outcome (for example, a failed log-in attempt or a successful log-in attempt), an account identifier (for example, an account number), a user identifier or credential (for example, a first and last name of the user), a country or region, an event type (for example, a log-in attempt), and the like. Accordingly, in some embodiments, the time-bucketed data 225 (or a portion thereof) may be associated with one or more data points. In some embodiments, the time-bucketed data 225 includes the one or more data points. Accordingly, in some embodiments, the time-bucketed data 225 includes the event count for the bucket and one or more data points associated with events included in the bucket.

In some embodiments, the time-bucketed data 225 may be one-dimensional (associated with a single data point). As one example, the time-bucketed data 225 includes event counts associated with an account identifier (as a data point). Accordingly, in such embodiments, the time-bucketed data 225 (each event count included therein) may be associated with the same data point. Alternatively or in addition, the time-bucketed data 225 may be multi-dimensional (associated with more than one data point). As one example, the time-bucketed data 225 includes event counts associated with an account identifier (as a first data point) and an IP address (as a second data point). In some embodiments, each data point is the same for each event count. For example, each of the event counts are associated with the same account identifier (as the first data point) and the same IP address (as the second data point). Alternatively or in addition, in some embodiments, one or more of the data points are different for at least one event count. As one example, each event count may be associated with the same account identifier (as a first data point), such that the time-bucketed data 225 is associated with the same account identifier, while a first portion of the event counts are associated with a first IP address and a second portion of the event counts are associated with a second IP address different from the first IP address (as a second data point). Following this example, the time-bucketed data 225 may indicate that a user typically logs-in to his/her account from a work-related IP address (the first IP address) between 9:00 am-5:00 pm. However, anytime outside of 9:00 am-5:00 pm the user typically logs-in from a non-work-related IP address (the second IP address). Accordingly, the time-bucketed data 225 may be associated with the same first data point while various portions of the time-bucketed data 225 may be associated with a different second data point.

The server 110 may receive the time-bucketed data 225 directly from one or more of the user devices 125, the customer server 105, or a combination thereof. Alternatively or in addition, as seen in FIG. 1, the event database 115 may store the time-bucketed data 225, as described in greater detail below. Accordingly, in some embodiments, the server 110 accesses the time-bucketed data 225 from the event database 115. In some embodiments, the time-bucketed data 225 is real-time (or near real-time) data. For example, the time-bucketed data 225 may be received by the event database 115, the server 110, another component of the system 100, or a combination thereof in real-time (or near real-time). Alternatively or in addition, in some embodiments, the time-bucketed data 225 is historical data. For example, the time-bucketed data 225 may be received by the event database 115, the server 110, another component of the system 100, or a combination thereof according to a predetermined schedule (for example, every hour, day, week, or the like).

As seen in FIG. 2, the memory 205 may also store an interval approximation application 350. The interval approximation application 350 is a software application executable by the electronic processor 200. As described in more detail below, the interval approximation application 350, when executed by the electronic processor 200, accesses the time-bucketed data 225 and determines an event interval based on the time-bucketed data 225. An event interval may represent an approximated distribution of events for a bucket (across a bucket time window of the bucket). For example, in some embodiments, the interval approximation application 350 determines the event interval such that events are evenly distributed across the bucket time window for the bucket as a whole. The interval approximation application 350 may store the determined event intervals as interval data (for example, in the memory 205). Alternatively or in addition, the server 110 may transmit the interval data 355 to another component of the system 100. As one example, in some embodiments, the server 110 may transmit interval data 355 to the interval database 130 for storage (as seen in FIG. 1). As another example, the server 110 may transmit the interval data 355 to the fraud detection server 120 to support security and anti-fraud functionality performed by the fraud detection server 120 (described in greater detail below). The functionality (or a portion thereof) described herein as being performed by the interval approximation application 350 may be distributed among multiple software applications. Furthermore, the interval approximation application 350 may perform additional functionality than the functionality described herein.

The fraud detection server 120 may include one or more desktop computers, laptop computers, tablet computers, terminals, smart telephones, smart televisions, smart wearables, servers, databases, other types of computing devices, or a combination thereof. Although not illustrated in FIG. 1, the fraud detection server 120 may include similar components as the server 110, such as an electronic processor, a memory, and a communication interface. The fraud detection server 120 may also include one or more input devices (for example, a keyboard, a keypad, a mouse, a joystick, a touchscreen, and the like) and one or more output devices (for example, a display device, a touchscreen, a printer, a speaker, and the like) that receive input from a user and provide output to a user.

The fraud detection server 120 stores and provides a plurality of applications 360 (referred to herein collectively as “the applications 360” and individually as “an application 360”). An application 360 is a software application executable by an electronic processor of the fraud detection server 120. An application 360, when executed by an electronic processor, performs one or more security or anti-fraud functions, such as fraud detection, fraud monitoring, and the like. For example, an application 360 may support account takeover prevention, fraudulent account creation prevention, and the like. In some embodiments, the fraud detection server 120 supports multiple applications 360. However, in other embodiments, the system 100 may include multiple fraud detection servers 120 each providing a different application 360. As one example, the system 100 may include a first fraud detection server 120 providing an account takeover prevention application (a first application 360), a second fraud detection server 120 providing an online account origination application (a second application 360), and the like. In some embodiments, the fraud server 120 is part of a computing network, such as a distributed computing network, a cloud computing service, or the like.

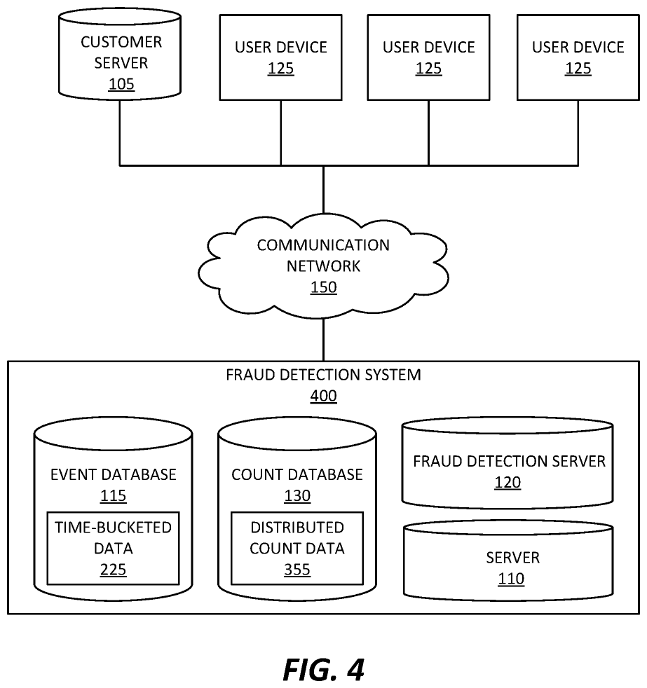

In some embodiments, the fraud detection server 120 interacts (or communicates) with one or more components of the system 100 as part of performing the one or more security or anti-fraud functions (such as recognizing patterns with respect to time intervals between similar events). As one example, the fraud detection server 120 may access the time-bucketed data 225 from the event database 115, the server 110, another component of the system 100, or a combination thereof. As another example, the fraud detection server 120 may access the interval data 355 from the interval database 130, the server 110, another component of the system 100, or a combination thereof. Accordingly, in some embodiments, one or more components of the system 100 may be implemented as part of a fraud detection system 400, as seen in FIG. 4. In the illustrated example of FIG. 4, the server 110, the event database 115, the fraud detection server 120, and the interval database 130 are implemented as part of the fraud detection system 400.

The user devices 125 and the customer server 105 may include one or more desktop computers, laptop computers, tablet computers, terminals, smart telephones, smart televisions, smart wearables, servers, databases, other types of computing devices, or a combination thereof. Although not illustrated in FIG. 1, the user devices 125 and the customer server 105 may include similar components as the server 110, such as an electronic processor, a memory, and a communication interface. The user devices 125 and the customer server 105 may also include one or more input devices (keyboard, keypad, mouse, joystick, touchscreen, and the like) and one or more output devices (display device, touchscreen, printer, speaker, and the like) that receive input from a user and provide output to a user.

The customer server 105 may provide an application or service (such as a cloud-based service) to a user or customer (for example, an end user, a group of users, an organization, another user entity, or the like). As one example, an entity, such as a financial institute, may manage the customer server 105 to provide a financial service (for example, an online banking service, a financial account management service, or the like). A user may interact with the customer server 105 (in this example, the financial service) either directly via an input/output device of the customer server 105 or indirectly via one or more intermediary devices (for example, a user device 125). In some embodiments, the customer server 105 is part of a computing network, such as a distributed computing network, a cloud computing service, or the like. The customer server 105 may communicate with the server 110, the fraud detection server 120, another component of the system 100, or a combination thereof as part of providing a cloud-based service to a user using an intermediary device (for example, a user device 125). In some embodiments, the customer server 105, the user device 125, or a combination thereof may communicate with the fraud detection system 400 of FIG. 4 to leverage fraud detection services provided via the application(s) 360 of the fraud detection server 120 and associated data (for example, the time-bucketed data 225, the interval data 355, and the like). Accordingly, in some embodiments the fraud detection system 400 is a cloud-based service or application provided through (or accessible by) a customer environment (for example, one or more of the user devices 125, the customer server 105, or a combination thereof).

As noted above, in some embodiments, the event database 115 stores the time-bucketed data 225. In some embodiments, the event database 115 receives the time-bucketed data 225 from one or more of the user devices 125, the customer server 105, or a combination thereof. Alternatively or in addition, in some embodiments, the event database 115 receives event data from one or more of the user devices 125, the customer server 105, or a combination thereof. Event data includes data (or data points) relating to an event, such as a log-in attempt, an account creation, or the like. Data relating to an event may include, for example, a timestamp, an IP address, a service provider, an event outcome, an account identifier, a user identifier or credential, a country or region, an event type, and the like. As one example, when the event is a log-in attempt, the event data may include a timestamp of the log-in attempt, an IP address associated with the log-in attempt, a service provider associated with the log-in attempt, a log-in attempt outcome (for example, successful log-in or a failed log-in), an account identifier associated with the log-in attempt, a user identifier or credentials used for the log-in attempt (for example, an entered username, password, account number, account type, or the like), and the like.

In some embodiments, the event data in real-time (or near real-time) data. For example, the event data is received by the event database 115, the server 110, another component of the system 100, or a combination thereof in real-time (or near real-time). Alternatively or in addition, in some embodiments, the event data is historical data. For example, the event data may be received by the event database 115, the server 110, another component of the system 100, or a combination thereof according to a predetermined schedule (for example, every hour, day, week, or the like). The event database 115 may process (or transform) the event data into time-bucketed data (for example, the time-bucketed data 225). In some embodiments, the event database 115 may analyze the event data (for example, a timestamp for each event) and assign each event included in the event data to a bucket based on a timestamp associated with the event and a bucket time window of the bucket. As one example, with reference to FIG. 3, when the timestamp of the event is 12:03 pm, the event database 115 may assign the event to a bucket having a bucket time window that includes 12:03 pm (for example, the first bucket 302A).

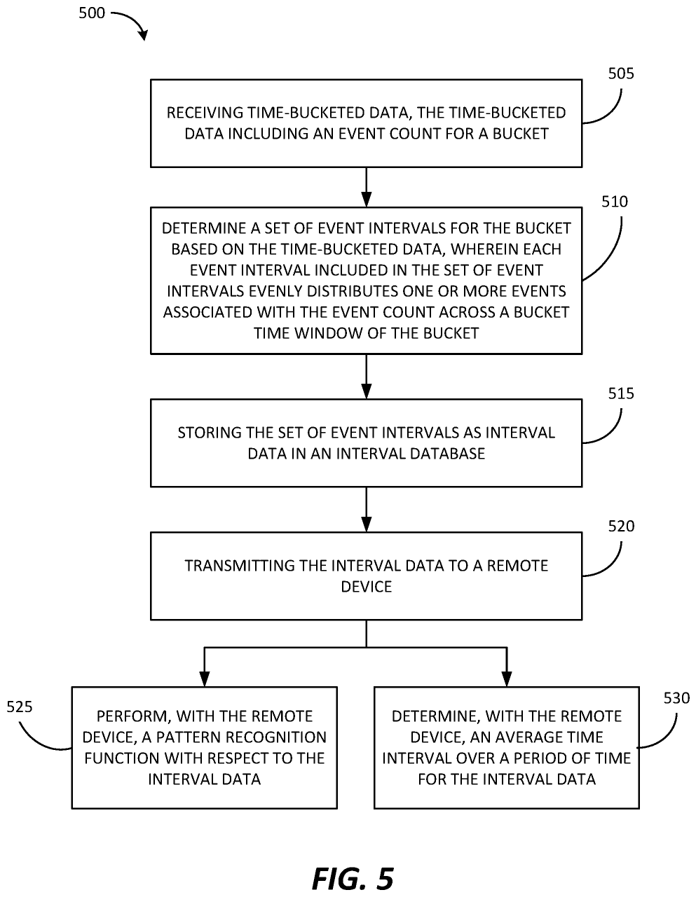

FIG. 5 is a flowchart illustrating a method 500 for approximating event intervals according to some embodiments. The method 500 is described as being performed by the server 110 and, in particular, the electronic processor 200 through execution of the interval approximation application 350. However, as noted above, the functionality performed by the server 110 (or a portion thereof) may be performed by other devices (via an electronic processor executing instructions), including, for example, one or more user devices 125, the customer server 105, the fraud detection server 130, another component of the system 100, or a combination thereof.

As seen in FIG. 5, the method 500 includes receiving (or accessing) the time-bucketed data 225 (at block 505). As noted above, in some embodiments, the time-bucketed data 225 includes an event count for a bucket, one or more data points associated with one or more events included in the bucket, or a combination thereof. As also noted above, the electronic processor 200 may receive the time-bucketed data 225 from the customer server 105, one or more user devices 125, the event database 115, or a combination thereof.

After receiving the time-bucketed data 225 (at block 505), the electronic processor 200 determines an event interval for the bucket based on the time-bucketed data (at block 510). In some embodiments, the electronic processor 200 determines the event interval such that one or more events associated with the event count are evenly distributed across a bucket time window for the bucket. Accordingly, in some embodiments, when an event occurred is assumed or approximated. The electronic processor 200 may determine the event interval by dividing the bucket time window for a bucket by the event count for the bucket, where the quotient is the event interval. As one example, where a bucket has event count “N,” a bucket time window of “TimeBucketSize,” and starts at time “TimeBucketStart,” the electronic processor 200 may use the following formula for determining a time of a first event in a bucket: TimeBucketStart+TimeBucketSize/N/2. The remaining events within the bucket will follow by being spaced out by: TimeBucketSize/N. This results in a time “space” of TimeBucketSize/N/2 between the last event in a bucket and the start of the following bucket.

In some embodiments, the electronic processor 200 determines (or approximates) one or more time intervals for a bucket for which a current timestamp falls (for example, when a time bucket window is fixed at five minutes, a current bucket starts at 1:00 pm, and a current timestamp is 1:03 pm). In such embodiments, the “TimeBucketSize” variable may be equal to: CurrentTimeStamp−TimeBucketStart.

As seen below, Table 1 includes three examples. The following examples use the “|” character to denote boundaries between buckets. The numbers between these boundaries are event counts for that given bucket. For the purpose of these examples, the buckets on the right are treated as the most recent buckets. Additionally, for each example, the buckets have a fixed time bucket window of one hour (or 60 minutes).

TABLE 1

| Time-Bucketed Data | Time Intervals (oldest |
|---|---|
| (oldest to recent) | to recent) |
| \|1\|0\|1\|1\| | 2 hours, 1 hour |
| \|2\|2\|2\| | 30 minutes, 30 minutes, |
| | 30 minutes, 30 minutes, |
| | 30 minutes |
| \|2\|1\|3\| | 30 minutes, 45 minutes, |
| | 40 minutes, 20 minutes, |
| | 20 minutes |

In some embodiments, the electronic processor 200 stores the determined event intervals as interval data (for example, the interval data 355) (at block 515). For example, the electronic processor 200 may store the interval data 355 in the memory 205 of the server 110. Alternatively or in addition, in some embodiments, the electronic processor 200 may transmit the interval data 355 to a remote device (at block 520), such as the interval database 130 for storage, the fraud detection server 120, another component of the system 100, or a combination thereof. As one example, the electronic processor 200 may transmit the interval data 355 to the fraud detection server 120 to support security and anti-fraud functionality performed by the fraud detection server 120.

As one example use case, the fraud detection server 120 may access the interval data 355 and performs a pattern recognition function with respect to the interval data 355 to determine how frequently a particular user logs-in to an account from a particular IP address (at block 525). As one example pattern, the fraud detection server 120 may determine that a user typically logs-in from a work-related IP address between 9:00 am-5:00 pm. However, anytime outside of 9:00 am-5:00 pm the user typically logs-in from a non-work-related IP address. The fraud detection server 120 may use this pattern to support security and anti-fraud functionality. For example, when a future log-in attempt for that user is detected from a work-related IP address between 9:00 am-5:00 pm, the log-in attempt may not be flagged as suspicious or as potential fraud. As another example, when a future log-in attempt for that user is detected from a third unknown IP address between 9:00 am-5:00 pm, the log-in attempt may be flagged as suspicious or as potential fraud. According to this example, further fraud detection functions may be performed with respect to this log-in attempt to determine whether the log-in attempt is fraudulent.

In some embodiments, the fraud detection server 120, the electronic processor 200, or a combination thereof, may determine an average (or mean) time interval over a period of time (at block 530), such as a week or an hour, based on the interval data 355. As one example, with respect to the second example from Table 1 (above), the fraud detection server 120 may determine an average time interval between events is thirty minutes. Accordingly, based on this average time interval, the fraud detection server 120 may identify events as potential fraud when events occur outside of this average time interval. Alternatively or in addition, the fraud detection server 120, the electronic processor 200, or a combination thereof, may determine a standard deviation of intervals based on the interval data 355. As one example, with respect to the third example from Table 1 (above), the fraud detection server 120 may determine a standard deviation of intervals as approximately ten minutes. Accordingly, based on this standard deviation, the fraud detection server 120 may identify events as potential fraud when events occur such that the associated time intervals differ by more than one the standard deviation.

As yet another example use case, the fraud detection server 120 may implement the following example rule, which uses a combination of mean interval for login successes by a particular account identifier, standard deviation of intervals for login successes by a particular account identifier, and most recent interval:

```
if (
  Account.Recent.Login.Success.count(168) > 1
) then
  if (
    Account.Recent.Login.Success.intervalAvg(168) −
Account.Recent.Login.Success.intervalStddev(168) <
Account.Recent.Login.Success.interval(168) and
    Account.Recent.Login.Success.intervalAvg(168) +
Account.Recent.Login.Success.intervalStddev(168) >
Account.Recent.Login.Success.interval(168)
  ) then rule.trigger
  end
end
```

The example rule (above) determines whether a most recent login interval of an account differs significantly from an average login interval for the account. The example rule considers frequency variance through a calculation of standard deviation. As one example, a user may usually login every 24 hours on average (i.e., once per day) with a standard deviation of 1 hour. When a standard deviation of +/−1 is acceptable, then when the user logs in next time within 23 or 25 hours, the fraud detection server 130 may determine this login attempt or activity as normal (not potential fraud). However, when the user's account is being logged in three times a day (for example, an average of 8 hours apart between logins), the fraud detection server 130 may flag these login attempts as suspicious or potential fraud.

Accordingly, the use of standard deviation takes into account of variance seen in login. As one example, when the fraud detection server 130 accepts a standard deviation of +/−0.5 hours, the fraud detection server 130 performs a more aggressive approach in terms of flagging suspicious activities. In contrast, the fraud detection server 130 may perform a less aggressive approach when the fraud detection server 130 accepts a standard deviation of +/−3 hours.

Thus, the embodiments described herein provide, among other things, methods and systems for approximating event intervals.

It is to be understood that the embodiments described herein is not limited in its application to the details of construction and the arrangement of components set forth in the description or illustrated in the accompanying drawings. The embodiments described herein are capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and may include electrical connections or couplings, whether direct or indirect. Also, electronic communications and notifications may be performed using any known means including direct connections, wireless connections, etc.

A plurality of hardware and software based devices, as well as a plurality of different structural components may be utilized to implement the embodiments described herein. In addition, embodiments described herein may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the embodiments described herein may be implemented in software (for example, stored on non-transitory computer-readable medium) executable by one or more processors. As such, it should be noted that a plurality of hardware and software based devices, as well as a plurality of different structural components, may be utilized to implement the embodiments described herein. For example, “mobile device,” “computing device,” and “server” as described in the specification may include one or more electronic processors, one or more memory modules including non-transitory computer-readable medium, one or more input/output interfaces, and various connections (for example, a system bus) connecting the components.

It should be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Various features and advantages of the embodiments are set forth in the following claims.

What is claimed is:

1. A system for approximating event intervals, the system comprising:
an electronic processor configured to
receive time-bucketed data, the time-bucketed data including an event count for a bucket,
determine a set of event intervals for the bucket based on the time-bucketed data, wherein each event interval included in the set of event intervals evenly distributes one or more events associated with the event count across a bucket time window of the bucket, and
storing the set of event intervals as interval data in an interval database.

2. The system of claim 1, wherein the time-bucketed data includes a first data point associated with each of the one or more events.

3. The system of claim 2, wherein the first data point associated with each of the one or more events is the same.

4. The system of claim 1, wherein the time-bucketed data includes a second data point associated with each of the one or more events, the second data point different from the first data point.

5. The system of claim 4, wherein the first data point is an account identifier and the second data point includes at least one selected from a group consisting of a timestamp, an IP address, a service provider, an event outcome, an account identifier, a user identifier or credential, a country or region, and an event type.

6. The system of claim 1, wherein each event interval included in the set of event intervals is a quotient of the bucket time window divided by the event count.

7. The system of claim 1, wherein the electronic processor is configured to perform a fraud detection function based on the interval data.

8. The system of claim 7, wherein the electronic processor is configured to perform the fraud detection function in real-time.

9. The system of claim 1, wherein the electronic processor is configured to transmit the interval data to a fraud detection system, the fraud detection system configured to perform a fraud detection function based on the interval data.

10. The system of claim 9, wherein the fraud detection system is configured to determine at least one selected from a group consisting of an average, a standard deviation, and a mean for each event interval included in the interval data, and wherein the fraud detection system is configured to perform the fraud detection function based on the at least one selected from the group consisting of the average, the standard deviation, and the mean for each event interval included in the interval data.

11. A method for approximating event intervals, the method comprising:
receiving time-bucketed data, the time bucketed data including an event count for a bucket;
determining, with an electronic processor, a set of event intervals for the bucket based on the time-bucketed data, wherein each event interval included in the set of event intervals evenly distributes one or more events associated with the event count across a bucket time window of a corresponding bucket; and
storing the set of event intervals as interval data in an interval database.

12. The method of claim 11, wherein determining the set of event intervals for the bucket includes dividing the bucket time window by the event count, wherein each event interval is a quotient of dividing the bucket time window by the event count.

13. The method of claim 11, further comprising:
accessing the interval data; and
performing a fraud detection function based on the interval data.

14. The method of claim 11, wherein receiving the time-bucketed data includes receiving at least one data point associated with each of the one or more events.

15. A non-transitory, computer-readable medium storing instructions that, when executed by an electronic processor, perform a set of functions, the set of functions comprising:
receiving time-bucketed data, the time bucketed data including event counts for a plurality of buckets;
for each bucket included in the plurality of buckets,
determining a set of event intervals based on at least a portion of the time-bucketed data, wherein each event interval included in the set of event intervals evenly distributes one or more events across a bucket time window; and
storing the set of event intervals as interval data.

16. The computer-readable medium of claim 15, wherein the set of functions further comprises:
determining an average event interval over at least two buckets included in the plurality of buckets.

17. The computer-readable medium of claim 15, wherein the set of functions further comprises:
determining a standard deviation between two or more event intervals.

18. The computer-readable medium of claim 15, wherein determining the set of event intervals includes dividing the bucket time window by the event count, wherein each event interval included in the set of event intervals is a quotient of dividing the bucket time window by the event count.

19. The computer-readable medium of claim 15, wherein the set of functions further comprises:
performing a fraud detection function based on the interval data.

20. The computer-readable medium of claim 15, wherein the set of functions further comprises:
transmitting the interval data to a fraud detection system.
